(19) United States
(12) Patent Application Publication
(10) Pub. No.: US 2004/0209644 A1
(43) Pub. Date: Oct. 21, 2004

(54) Cellular phone installation adapted to capture and view images while providing telephone communication service simultaneously

(76) Inventors: Kuei Hsiung Chang, Taipei (TW); Tung Tai Yuan, Taoyuan City (TW); Tsung Liang Tsai, Yuan Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/603,827

(22) Filed: Jun. 26, 2003

(30) Foreign Application Priority Data
Apr. 15, 2003 (TW) 92108625

(51) Int. Cl. H04B 1/00

(52) U.S. Cl. 455/556.1

(57) ABSTRACT

There is disclosed a cellular phone installation adapted to capture and view image while providing telephone communication service simultaneously and a design method of implementing the same. While a cellular phone installation is used to capture or view images, an interrupt control unit is forced to intercept the transmission between a digital baseband processing unit and a display module for driving a image capture processing module to transfer the captured image and display the captured image on a display module. In this manner, the cellular phone installation is able to conduct telephone communication in the middle of image capture or viewing, and the convenience of using the cellular phone installation is improved. Also, the digital baseband processing unit is able to read out the captured image from the image capture processing module via a serial bus during the free intervals between busy telephone communication periods of the cellular phone installation, and transfer the readout image to a memory unit.

### FIELD OF THE INVENTION

The present invention is related to a cellular phone installation adapted to capture and view image while providing telephone communication service simultaneously, and more particularly to a cellular phone installation capable of allowing the manipulation of conducting telephone communication while capturing and viewing images simultaneously.

### BACKGROUND OF THE INVENTION

Owing to the burgeoning advancement on communication technology, the bandwidth of mobile communication is significantly increased and the convenience rendered to people has greatly improved their living standards. Also the gap caused by the unfamiliarity between people has been removed accordingly. The cellular phone installation today has been upgraded to be provided with real-time image capture and viewing as well as multimedia messaging capabilities. This enables the cellular phone installation to become a powerful and multifunctional portable facility, and promotes the added value of the cellular phone installation.

Unfortunately, the current cellular phone installation is not possible to provide telephone communication service while image capture and viewing operation is in progress. The user is forced to make an alterative choice to carry out either one of the image capture/viewing and telephone communication. This would lead to a situation where the user can not help but terminate the execution of the image capture and viewing function window while an incoming call is ringing, or otherwise ignore the incoming call but remain the operation of image capture and viewing. It would bring about some inconvenience to the user and thus debase the versatility of the cellular phone installation.

The present invention is designated to aim at providing a cellular phone installation adapted to capture and view images while providing telephone communication service simultaneously for tackling the problems of such awkwardness, and thereby facilitate the maneuverability of the cellular phone installation.

### SUMMARY OF THE INVENTION

The primary objective of the present invention is targeted at the provision of a cellular phone installation that can accommodate telephone communication service while image capture and viewing process is undertaking, which allows the user to dexterously manipulate the cellular phone installation in a convenient way.

A secondary objective of the present invention is to provide a design method of a cellular phone installation that can be adapted to capture and view images while providing telephone communication service simultaneously, the method is accomplished by storing the captured images in a built-in memory of an image sensing microprocessor, and allowing a digital baseband processing unit to read out the captured image and transmit the readout image to a memory unit for storage. The digital baseband processing unit may utilize the free intervals between busy telephone communication periods of the cellular phone installation to read out the captured image and stored the captured image in a memory unit while the cell phone is viewing captured images.

The architecture of the cellular phone installation according to the present invention mainly includes an analog baseband processing unit for receiving an input signal and processing the input signal into a baseband signal, and transmitting the baseband signal to a digital baseband processing unit. The digital baseband processing unit is used to receive the baseband signal and process the baseband signal into an audio signal to be transmitted to an audio signal processing unit. The digital baseband processing unit may use a parallel bus to transmit data to a display module for image display. Moreover, an interrupt control unit is used to handle the transmission between the digital baseband processing unit and the display module.

While an image capture processing module is in service, the interrupt control unit will intercept the transmission between the digital baseband processing unit and the display module for allowing the image capture processing module to perform data transfer to the display module for image display. The image capture processing module includes an image sensor intended for capturing an image and an image sensing microprocessor intended for image processing. The image sensor is responsible for the transmission of the captured image to the image sensing microprocessor, and then the captured image being processed by the image sensing microprocessor is further transmitted to the display module for image display. If the cellular phone installation is capturing image, the captured image is stored in a built-in memory of the image sensing microprocessor, so that the digital baseband processing unit is able to read out the image stored therein via a serial bus and store the readout image in a memory unit during the free intervals between busy telephone communication periods. In addition, the digital baseband processing unit is able to transmit texts or images to be displayed via the serial bus and drive the image sensing microprocessor to display the texts or images on the display module.

The cellular phone installation according to the present invention is able to transmit data by the digital baseband processing unit to the display module for image display when the cellular phone installation is conducting telephone communication. While the cellular phone installation is viewing or capturing images, an interrupt control unit is forced to intercept the transmission between the digital baseband processing unit and the display module for allowing an image sensing microprocessor within an image capture processing module to transmit the image to be viewed to the display module.

The features and advantages of the present invention will become more apparent through the following descriptions with reference to the accompanying drawings, in which:

### BRIEF DESCRIPTION OF THE DRAWINGS

FIG. 1 is a block diagram showing a preferred embodiment of the present invention.

### DETAILED DESCRIPTION OF THE PREFERRED EMBODIMENT

The architecture of a cellular phone installation adapted to capture and view images while providing telephone communication service simultaneously and the design rule thereof according to the present invention allows a cellular phone installation equipped with the capabilities of capturing and viewing images to provide telephone communication service in synchronization with the operation of image capture and viewing for a user, and thus upgrade the functionality of the cellular phone installation. A user may proceed to telephone communication service straightforwardly by using a cellular phone installation without the need of terminating the current operation of image capture and viewing performing on the cellular phone installation.

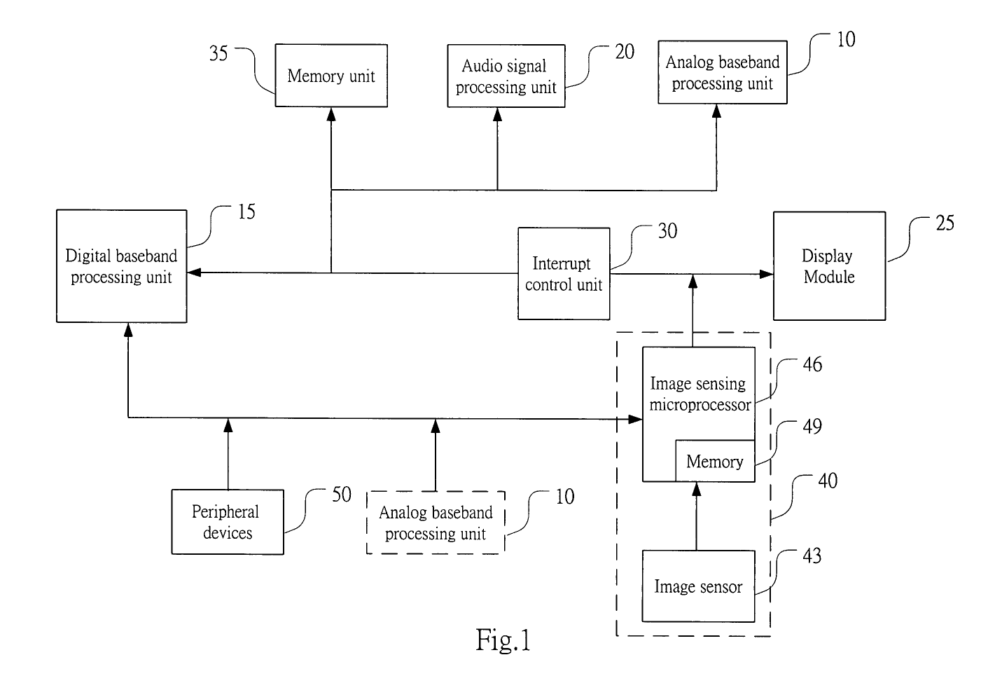

References are now made to FIG. 1, which is a functional block diagram of a cellular phone installation according to a preferred embodiment of the present invention. As shown in FIG. 1, while a cellular phone installation capable of capturing and viewing images according to the present invention desires to render telephone communication, an analog baseband processing unit 10 is employed to receive an input signal and processes the input signal into a baseband signal and transmits the baseband signal to a digital baseband processing unit 15. The digital baseband processing unit 15 transmits an audio signal that is derived by processing the baseband signal to an audio signal processing unit 20. The digital baseband processing unit 15 is provided with the capability of transmitting data to be displayed to a display module 25 via a parallel bus in the middle of telephone communication. However, this can be done on the condition that an interrupt control unit 30 installed upon the parallel bus between the digital baseband processing unit 15 and the display module 25 does not intercept the parallel bus. The parallel bus may be a data bus or a control bus. The display module 25 may be performed by a liquid crystal display (LCD) or an organic electroluminescent display (OLED). A memory unit 35 is provided and furnished with a static random access memory (SRAM) and a flash memory intended for storing the data in conjunction with the system of cellular phone installation. Both of the audio signal processing unit 20 and the memory unit 35 are configured to communicate with the digital baseband processing unit 15 via the parallel bus.

While the cellular phone installation is carrying on image capture or viewing operation, the interrupt processing unit 30 will intercept the parallel bus handing the transmission between the digital baseband processing unit 15 and the display module 25. An image capture processing module 40 is provided and comprised of an image sensor 43 and an image sensing microprocessor 46. The image sensor 43 may be made up of a charge-coupled device (CCD) or a CMOS device. The image sensor 43 is responsible for the transmission of captured image to the image sensing microprocessor 46. The image sensing microprocessor 46 may optionally process the captured image with a compression procedure, and transfer the image to the display module via the parallel bus for image display. While the image capture process is in progress, the captured image is stored in a built-in memory 49 of the image sensing microprocessor 46 with either a compressed or an uncompressed format.

The digital baseband processing unit 15 is able to make use of free intervals between telephone communication periods to drive the image sensing microprocessor 46 via the serial bus to read out the image stored in the memory 49, and then transmit the readout image via the parallel bus to the memory unit 35 for storage. The digital baseband processing unit 15 also may perform image reading/storing operation as described above while the captured image is undergoing compression and retained in the memory 49. If the user desires to view the images stored in the memory unit 35 or the graphics or texts related to the caller ID number, the images, texts or graphics that are desired to display can be transmitted from the digital baseband processing unit 15 through a serial bus to the image sensing microprocessor 26, and then transmitted from the image sensing microprocessor 26 to the display module 25 for display.

If the cellular phone installation is necessary to proceed to capture image or view image while an incoming call is ringing or telephone communication is in progress, the graphics or texts required to be displayed can be transmitted from the digital baseband processing unit 15 through the serial bus to the image sensing microprocessor 46, and transmitted from the image sensing microprocessor 46 to the display module 25 for display. While the image capture or viewing operation of the cellular phone installation is terminated, the interrupt control unit 30 is able to resume the transmission over the parallel bus between the digital baseband processing unit 15 and the display module 25.

Besides, the abovementioned analog baseband processing unit 10 may be installed upon the serial bus, and the serial bus may be further connected with a plurality of peripheral devices 50, such as keypad, serially-interfaced memory and LED alarm indicators. The serial bus may alternatively provide a clock transmission line and a bi-directional data transmission line, or provide a clock transmission line, a uni-directional data-writing transmission line and a uni-directional data-reading transmission line. The abovementioned analog baseband processing unit 10 and the digital baseband processing unit 15 can be integrated into a single integrated circuit device, or the digital baseband processing unit 15 and the audio signal processing unit 20 can be integrated into a single integrated circuit device, or otherwise the baseband processing unit 10, the digital baseband processing unit 15, and the audio signal processing unit 20 can be integrated into a single integrated circuit device.

To sum up, the basic principle of achieving a cellular phone installation that can conduct telephone communication while capturing or viewing images at the same time according to the present invention is established by installing an interrupt control unit 30 upon the parallel bus between a digital baseband processing unit 15 and a display module 25. The interrupt control unit 30 can effect an influence on the transmission of the captured image by intercepting the parallel bus handling the transmission between the digital baseband processing unit 15 and the display module 25, and enabling an image sensing microprocessor 46 to transmit image and activate the display module 25 to display image. Besides, the image sensing microprocessor 46 is furnished with a built-in memory 49 prepared to store captured image. The digital baseband processing unit 15 is able to make use of free intervals between busy telephone communication periods to read out the image stored in the memory 49, and transmit the readout image to the memory unit 35 for storage. In this manner, a cellular phone installation can be provided to perform telephone communication at the same time image capture or viewing operation is progressing, which in turn enhances the properties of the cellular phone installation.

While the present invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. A cellular phone installation adapted to capture and view images while providing telephone communication service simultaneously, comprising:
an analog baseband processing unit for receiving an input signal and processing the input signal into a baseband signal;
a digital baseband processing unit for receiving and processing the baseband signal transmitted from the analog baseband processing unit;
an audio signal processing unit for receiving and processing an audio signal transmitted from the digital baseband processing unit;
a image capture processing module for capturing and processing images and communicating with the digital baseband processing unit;
a display module for receiving and displaying captured image transmitted from the digital baseband processing unit and the image capture processing module; and
an interrupt control unit handling the transmission between the digital baseband processing unit and the display module, and intercepting the transmission between the digital baseband processing unit and the display module when the image capture processing module is transmitting data to the display module and driving the display module to display captured image.

2. The cellular phone installation of claim 1 wherein the image capture processing module includes an image sensor and an image sensing microprocessor, the image sensor is used to capture an image and the image sensing microprocessor is used to receive data from the image sensor and the digital baseband processing unit and transmit received data to the display module.

3. The cellular phone installation of claim 1 wherein the image sensing microprocessor is furnished with a built-in memory.

4. The cellular phone installation of claim 1 wherein the digital baseband processing unit is configured to communicate with the display module via a parallel bus, and the interrupt control unit is installed upon the parallel bus between the digital baseband processing unit and the display module.

5. The cellular phone installation of claim 4 wherein the image capture processing module is configured to communicate with the display module via the parallel bus.

6. The cellular phone installation of claim 1 wherein the analog baseband processing unit, the audio signal processing unit, the memory unit and the digital baseband processing unit are configured to communication with each other via the parallel bus.

7. The cellular phone installation of claim 1 wherein the digital baseband processing unit is configured to communicate with the display module via a serial bus.

8. The cellular phone installation of claim 7 wherein the digital baseband processing unit is configured to communicate with the analog baseband processing unit via the serial bus.

9. The cellular phone installation of claim 7 wherein the serial bus is further connected with a plurality of peripheral devices.

10. The cellular phone installation of claim 1 wherein the digital baseband processing unit and the analog baseband processing unit are integrable into an integrated circuit.

11. The cellular phone installation of claim 1 wherein the digital baseband processing unit and the audio signal processing unit are integrable into an integrated circuit.

12. The cellular phone installation of claim 1 wherein the digital baseband processing unit, the analog baseband processing unit, and the audio signal processing unit are integrable into an integrated circuit.

13. A method of enabling a cellular phone installation to capture and view images while providing telephone communication service simultaneously, wherein data is transmitted from a digital baseband processing unit to a display module while the cellular phone installation is conducting telephone communication, and data is transmitted from an image capture processing module to the display module while the cellular phone installation is capturing images or viewing images, the method comprising:
enabling an interrupt control unit to intercept the transmission between the digital baseband processing unit and the display module; and
allowing the image capture processing module to transmit images to be displayed to the display module and allowing a telephone communication by the cellular phone installation simultaneously.

14. The method of enabling a cellular phone installation to capture and view images while providing telephone communication service simultaneously of claim 13 wherein the image capture processing module includes an image sensor and an image sensing microprocessor, and the images intended to be viewed is transmitted to the display module via the image sensing microprocessor.

15. The method of enabling a cellular phone installation to capture and view images while providing telephone communication service simultaneously of claim 14 wherein the images intended to be view is captured from the image sensor.

16. The method of enabling a cellular phone installation to capture and view images while providing telephone communication service simultaneously of claim 15 wherein captured images by the image sensor is stored in a built-in memory of the image sensing microprocessor.

17. The method of enabling a cellular phone installation to capture and view images while providing telephone communication service simultaneously of claim 16 wherein the captured images is compressed by the image sensing microprocessor and stored in the built-in memory of the image sensing microprocessor.

18. The method of enabling a cellular phone installation to capture and view images while providing telephone communication service simultaneously of claim 16 wherein the digital baseband processing unit is enabled to use free intervals between busy telephone communication periods of the cellular phone installation to read out image in the built-in memory of the image sensing microprocessor.

19. The method of enabling a cellular phone installation to capture and view images while providing telephone communication service simultaneously of claim 18 wherein the image sensing microprocessor is configured to communicate with the digital baseband processing unit via a parallel bus.

20. The method of enabling a cellular phone installation to capture and view images while providing telephone communication service simultaneously of claim 14 wherein images to be displayed is read out from a memory unit by the digital baseband processing unit and transmitted to the image sensing microprocessor.

21. The method of enabling a cellular phone installation to capture and view images while providing telephone communication service simultaneously of claim 13 wherein the digital baseband processing unit is enabled to transmit images to be displayed to an image sensing microprocessor within an image capture processing module when an additional image display service is requested during image capture or viewing operation, and thereby drive the image sensing microprocessor to transmit the images to be displayed to the display module.

22. The method of enabling a cellular phone installation to capture and view images while providing telephone communication service simultaneously of claim 21 herein the digital baseband processing unit is configured to communicate with the image sensing microprocessor via a serial bus.

23. The method of enabling a cellular phone installation to capture and view images while providing telephone communication service simultaneously of claim 13 wherein the digital baseband processing unit is configured to communicate with the display module via a parallel bus.
